(19) United States
(12) Patent Application Publication
(10) Pub. No.: US 2025/0156708 A1
(43) Pub. Date: May 15, 2025

(54) METHOD AND SYSTEM FOR OPTIMIZING DEEP LEARNING MODELS

(71) Applicant: MEDIATEK INC., Hsinchu City (TW)

(72) Inventors: Tzu-Yun Chien, Hsinchu City (TW); Bo-Yu Kuo, Hsinchu City (TW); Jui-Yang Hsu, Hsinchu City (TW); Kai-Ling Huang, Hsinchu City (TW); Sheng-Je Hung, Hsinchu CIty (TW)

(73) Assignee: MEDIATEK INC., Hsinchu City (TW)

(21) Appl. No.: 18/939,492

(22) Filed: Nov. 6, 2024

Related U.S. Application Data
(60) Provisional application No. 63/598,141, filed on Nov. 13, 2023.

(51) Int. Cl. G06N 3/08

(52) U.S. Cl. CPC G06N 3/08

(57) ABSTRACT

A method for optimizing deep learning models includes: initializing a plurality of pools, each including a plurality of candidate solutions; concurrently performing a plurality of tuning algorithms respectively within the plurality of pools during a single tuning run, thereby obtaining a plurality of selected candidate solutions; and generating an optimized model configuration based on the plurality of selected candidate solutions.

### CROSS REFERENCE TO RELATED APPLICATIONS

This application claims the benefit of U.S. Provisional Application No. 63/598,141, filed on Nov. 13, 2023. The content of the application is incorporated herein by reference.

### BACKGROUND

The present invention relates to the field of artificial intelligence and deep learning, and more particularly, to a method and a system for optimizing deep learning models.

The rapid advancement and widespread adoption of deep learning (DL) technologies have led to a proliferation of AI applications across various domains. To meet the escalating performance demands of these applications, particularly in edge computing scenarios, numerous deep learning accelerators (DLAs) have been proposed. These DLAs aim to optimize DL inference on edge devices, presenting new challenges in hardware utilization and software optimization.

Efficient deployment of DL models on multi-core DLA architectures requires sophisticated compiler solutions that can maintain high utilization of each DLA core while ensuring balanced workloads. This optimization process typically involves graph-level model transformations to address parallelization issues and reduce DRAM access. Key techniques in this process include layer fusion and tensor tiling, which are crucial for optimizing performance on multi-level memory hierarchies.

However, the process of finding optimal combinations of layer fusion and tensor tiling for a target DLA is exceptionally complex and labor-intensive when performed manually. The challenge is further compounded by the need to repeat this tuning process for each model and scenario across multiple target DLAs with varying hardware specifications, resulting in an impractically vast number of possible combinations.

To address these challenges, auto-tuning approaches have been adopted to reduce human effort in finding optimal configurations. However, the effectiveness of these approaches is complicated by the idiosyncratic nature of different DL models, each potentially requiring different auto-tuning algorithms such as evolutionary algorithms or reinforcement learning. Furthermore, when faced with an unknown model, the absence of a unified algorithm that performs well across all models necessitates the sequential execution of different tuning strategies, leading to inefficiencies in the optimization process.

### SUMMARY

With this in mind, it is one object of the present invention to provide a method and system for optimizing versatile models, addressing the challenge of efficiently tuning versatile models without prior knowledge of the most suitable tuning algorithm. This invention is characterized by remix tuning architecture and multi-pool mechanism. The remix tuning architecture employs multiple tuning algorithms independently and concurrently within a single tuning run. This architecture allows for dynamic utilization of various tuning algorithms and adaptively favors tuning algorithms producing better results during the optimization process. The remix tuning architecture ensures that the method and the system of the present invention can efficiently navigate complex search spaces, leveraging the strengths of different tuning algorithms as needed. In the multi-pool mechanism, each pool corresponds to a distinct tuning algorithm and a distinct search space. The multi-pool mechanism enables individual solution generation within each algorithm-specific pool, allowing each tuning algorithm to operate according to its unique characteristics. Simultaneously, the multi-pool mechanism uses cross-pool selection based on unified metrics, ensuring that the best-performing solutions are identified regardless of their originating tuning algorithm.

According to one embodiment, a method for optimizing deep learning models is provided. The method comprises: initializing a plurality of pools, each including a plurality of candidate solutions; concurrently performing a plurality of tuning algorithms respectively within the plurality of pools during a single tuning run, thereby obtaining a plurality of selected candidate solutions; and generating an optimized model 1 configuration based on the plurality of selected candidate solutions.

According to one embodiment, a system for optimizing deep learning models is provided. The system comprises: a processor and a memory. The memory is configured to storing instructions. When the instructions are executed by the processor, the system is caused to perform operations comprising: initializing a plurality of pools each including a plurality of candidate solutions; concurrently performing a plurality of tuning algorithms respectively within the plurality of pools during a single tuning run, thereby obtaining a plurality of selected candidate solutions; and generating an optimized model configuration based on the plurality of selected candidate solutions.

According to one embodiment, a non-transitory computer-readable storage medium is provided. The non-transitory computer-readable storage medium is configured to store instructions. When the instructions are executed by a processor, the processor is caused to perform operations of: initializing a plurality of pools, each including a plurality of candidate solutions; concurrently performing a plurality of tuning algorithms respectively within the plurality of pools during a single tuning run, thereby obtaining a plurality of selected candidate solutions; and generating an optimized model configuration based on the plurality of selected candidate solutions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an operation flow of an optimizing process on a deep learning model according to one embodiment of the present invention.

FIG. 2 illustrates tuning algorithms and pools employed for optimizing a deep learning model according to one embodiment of the present invention.

FIG. 3 illustrates a flow chart of a method of optimizing a deep learning model according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

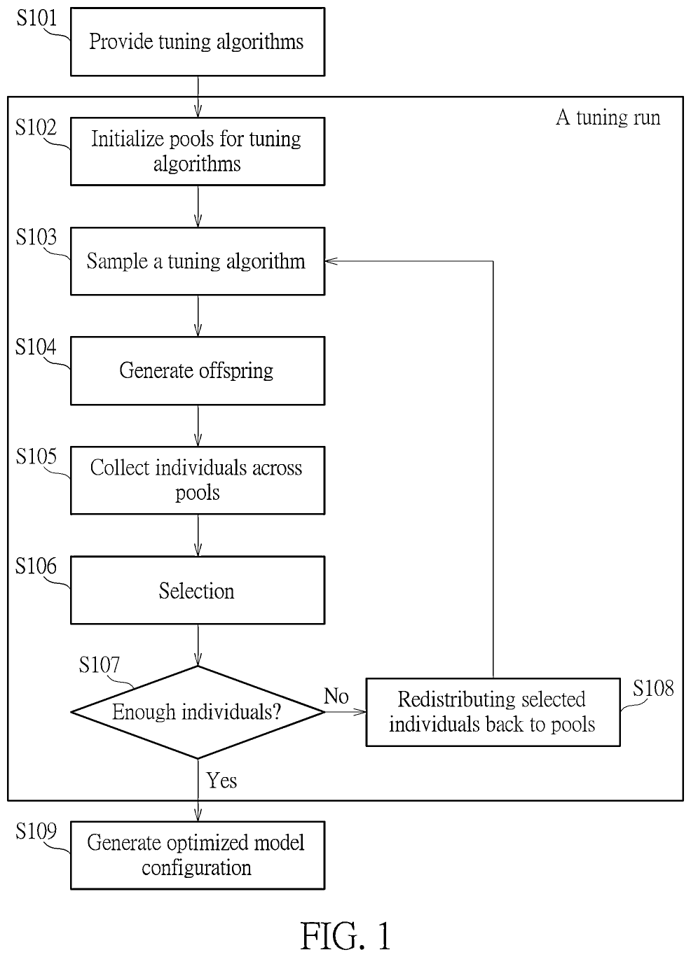

Please refer to FIG. 1, which illustrates an operation flow of an optimizing process on a deep learning model (or a machine learning model) according to one embodiment of the present invention. The optimization process is capable of generating an optimized model configuration, enhancing both performance and computational efficiency of the deep learning model. The optimized model configuration may be associated with optimization on layer fusion and tensor tiling configurations. Layer fusion and tensor tiling optimization aim to enhance parallel processing efficiency, balance workload, and reduce memory usage. The optimization process may prioritize either layer fusion or tensor tiling configurations, or a balanced/optimal combination of both, depending on the specific requirements of the model and deployment environment.

At step S101, a plurality of tuning algorithms ALG_0-ALG_n are provided for performing the optimization process. The tuning algorithms ALG_0-ALG_n can be operated concurrently within the remix tuning architecture of the present invention, each contributing to the exploration of a search space in its manner. In some embodiments, the tuning algorithms ALG_0-ALG_n are distinct from each other, ensuring a diverse approach to the optimization problem. In some embodiments, the tuning algorithms ALG_0-ALG_n include (but not limited to): evolutionary algorithms (e.g., genetic algorithms, differential evolution, or genetic programming), population-based algorithms capable of generating new candidate solutions based on existing ones, and/or hybrid algorithms that combine characteristics of evolutionary computation and other optimization techniques.

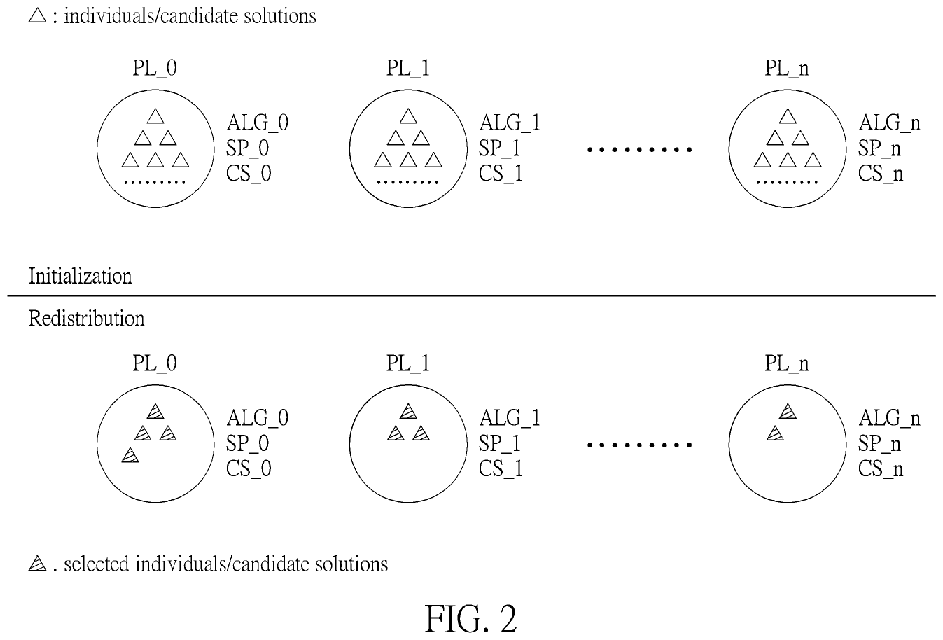

At step S102, a plurality of pools PL_0-PL_n are initialized and configured for the purpose of independently and concurrently executing the plurality of tuning algorithms ALG_0-ALG_n, respectively. In one embodiment shown by FIG. 2, each of the plurality of pools PL_0-PL_n is uniquely associated with a distinct algorithm of the tuning algorithms ALG_0-ALG_n. Furthermore, each of the plurality of pools PL_0-PL_n is configured to operate within a distinct search space of search spaces SP_0-SP_n. Additionally, each of the plurality of pools PL_0-PL_n is associated with a distinct set of compilation settings CS_0-CS_n. These associations enable the optimization process to simultaneously explore various compilation configurations, potentially leading to more efficient model optimization. The initialization process at step S102 ensures that the pools PL_0-PL_n are populated with an identical quantity of individuals, where each individual represents a candidate solution corresponding to a potential optimized model configuration. The initial uniformity in pool size establishes a fair starting point for all of the tuning algorithms ALG_0-ALG_n, allowing for an unbiased comparison of their performance. The above-mentioned multi-pool mechanism is the core the remix tuning architecture, which enables the concurrent execution of diverse optimization strategies, facilitating the exploration of various regions of the solution space simultaneously.

At step S103, a specific tuning algorithm of the tuning algorithms ALG_0-ALG_n is sampled to generate offspring. Specifically, a specific tuning algorithm of the tuning algorithms ALG_0-ALG_n is sampled on a basis of a number of individuals included in each of the plurality of pools PL_0-PL_n, which will be detailed later. It should be noted that step S103 is bypassed when it is first entered during initial population generation, where all tuning algorithms ALG_0-ALG_n are utilized to generate offspring. The sampling of a specific tuning algorithm would be performed when the flow returns to step S103 from step S108 in subsequent iterations.

At step S104, offspring individuals (i.e., offspring candidate solutions) are generated according to different scenarios. During the initial population generation, all tuning algorithms ALG_0-ALG_n are performed within their corresponding pools to generate offspring individuals. In subsequent iterations, the specific tuning algorithm sampled at step S103 is performed within its corresponding pool to generate offspring individuals. The offspring generated at step S104 corresponds to the compilation settings of the corresponding pool. This step ensures that new solutions (i.e., the offspring individuals/candidate solutions) are created in a manner consistent with the search strategy and search space of the algorithm being utilized.

At step S105, the individuals and the offspring individuals are collected across the pools PL_0-PL_n. Step S105 allows for cross-pool evaluation and selection. This facilitates the comparison of solutions generated by different tuning algorithms. At step S106, a selection operation is performed on the collected individuals and the collected offspring individuals to select specific individuals therefrom based on at least one unified metric, ensuring a fair comparison across solutions generated by different tuning algorithms. The at least one unified metric could be associated with one or more performance metrics relevant to the deep learning model being optimized.

At step S107, it is determined whether a number of the selected individuals (including selected individuals and selected offspring individuals) are enough. For example, it is determined that whether the number of the selected individuals reaches a predetermined threshold. If yes, the flow proceeds to step S109; otherwise, the flow proceeds to step S108 for further iteration. At step S109, a selection operation is performed on the selected individuals and the selected offspring individuals to generate the optimized model configuration, thereby determining optimal combination or at least one of configuration of layer fusion regarding the deep-learning model and configuration of tensor tiling regarding the deep-learning model.

If the total number of the selected individuals fails to reach the predetermined threshold, the flow advances to step S108, wherein the selected individuals are redistributed back to their respective corresponding pools (where the selected individuals originally come from). In some embodiments, after the redistribution, each of the plurality of pools PL_0-PL_n retains exclusively those selected individuals that originated from the pool. This approach ensures the preservation of algorithm-specific optimization trajectories while facilitating the global evaluation and selection process inherent to the remix tuning architecture of the present invention.

Upon returning to step S103 from step S108, the optimization process enters a new iteration. At step S103, it is calculated a sampling probability for each of the plurality of pools PL_0-PL_n. The sampling probability is calculated as a ratio of the number of selected individuals retained in the pool to a total number of selected individuals retained in the plurality of pools PL_0-PL_n. The sampling of the specific tuning algorithm is then performed based on these calculated sampling probabilities, where algorithms with higher probabilities have a greater chance of being selected. Such sampling mechanism tends to favor tuning algorithms whose corresponding pools contain more selected individuals, while still maintaining the possibility of selecting other algorithms. The sampling probabilities thus serve as weights in a selection process, promoting the use of more successful algorithms while preserving exploration potential through the possible selection of other algorithms.

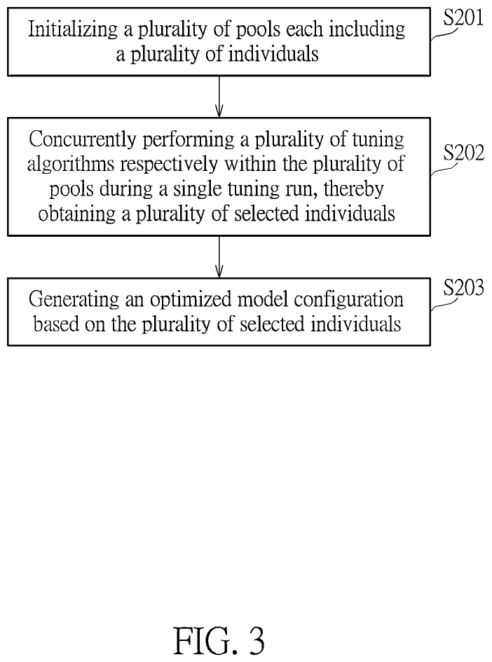

FIG. 3 illustrates a simplified flow of a method for optimizing deep learning models according to one embodiment of the present invention. As shown in the figure, the simplified flow includes the following steps:

Step S201: initializing a plurality of pools, each including a plurality of individuals (i.e., candidate solutions);

Step S202: concurrently performing a plurality of tuning algorithms respectively within the plurality of pools during a single tuning run, thereby obtaining a plurality of selected individuals (i.e., selected candidate solutions); and

Step S203: generating an optimized model configuration based on the plurality of selected candidate solutions.

Since principles and specific details of the foregoing steps have been explained in detail through the above embodiments, further descriptions will not be repeated here. It should be noted that the above flow may be possible, by adding other extra steps or making appropriate modifications and adjustments, to better improve flexibility and further improve efficiency of tuning the deep learning model.

In conclusion, the present invention introduces remix tuning architecture and multi-pool mechanism, an innovative method for optimizing deep learning models that significantly enhances efficiency and effectiveness through concurrent employment of multiple tuning algorithms. The present invention automates tuning algorithm selection and adapts to model performance, minimizing manual intervention and computational costs. The present invention also employs redistribution and retention strategy on solution search to preserve algorithm-specific optimization trajectories while maintaining solution diversity, striking a balance between exploration and exploitation. In addition, by leveraging a probabilistic selection mechanism on algorithm sampling, the present invention efficiently navigates complex optimization spaces, consolidating diverse solutions from multiple tuning algorithms. The present invention culminates in an optimized model configuration that determines optimal combinations of layer fusion strategies, tensor tiling configurations, and other optimization parameters, maximizing performance metrics such as inference speed, energy efficiency, and accuracy, minimizing the usage of dynamic random-access memory (DRAM), maximizing the utilization of high-speed cache in deep learning accelerators, and balancing core scheduling for multi-core DLAs.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, f and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for optimizing deep learning models, comprising:
initializing a plurality of pools, each including a plurality of candidate solutions;
concurrently performing a plurality of tuning algorithms respectively within the plurality of pools during a single tuning run, thereby obtaining a plurality of selected candidate solutions; and
generating an optimized model configuration based on the plurality of selected candidate solutions.

2. The method of claim 1, wherein each of the plurality of pools is associated with a distinct algorithm and configured to operate within a distinct search space.

3. The method of claim 1, wherein each of the plurality of pools is associated with a distinct set of compilation settings.

4. The method of claim 1, wherein step of initializing the plurality of pools comprises:
initializing each of the plurality of pools with an identical quantity of candidate solutions.

5. The method of claim 1, wherein the step of concurrently performing the plurality of tuning algorithms comprises:
sampling a specific tuning algorithm based on sampling probabilities that are proportional to a number of candidate solutions included in each of the plurality of pools;
generating offspring candidate solutions by performing the sampled specific tuning algorithm within its corresponding pool;
collecting the candidate solutions and the offspring candidate solutions across all of the plurality of pools; and
selecting one or more candidate solutions from the collected candidate solutions and the collected offspring candidate solutions based on at least one unified metric.

6. The method of claim 5, further comprising:
after selecting the one or more candidate solutions, redistributing the selected candidate solutions back to their respective corresponding pools.

7. The method of claim 6, wherein each of the plurality of pools retains exclusively those selected candidate solutions that originated from the pool after the selected candidate solutions are redistributed to their respective corresponding pools.

8. The method of claim 6, wherein the step of sampling the specific tuning algorithm comprises:
calculating a sampling probability with respect to each pool as a ratio of a number of selected candidate solutions retained in the pool to a total number of selected candidate solutions retained in all of the plurality of pools; and
sampling the specific tuning algorithm based on calculated sampling probabilities.

9. The method of claim 8, wherein the step of sampling the specific tuning algorithm based on calculated sampling probabilities comprises:
sampling the specific tuning algorithm corresponding to a pool having a highest sampling probability.

10. The method of claim 5, further comprising:
in response to determining that a number of the selected candidate solutions reaches a predetermined threshold, generating the optimized model configuration based on the selected candidate solutions.

11. The method of claim 1, wherein the optimized model configuration is associated with at least one of a configuration of layer fusion regarding a deep learning model and a configuration of tensor tiling regarding the deep learning model.

12. A system for optimizing deep learning models, comprising:
a processor; and
a memory storing instructions that, when executed by the processor, cause the system to perform operations comprising:
initializing a plurality of pools each including a plurality of candidate solutions;
concurrently performing a plurality of tuning algorithms respectively within the plurality of pools during a single tuning run, thereby obtaining a plurality of selected candidate solutions; and
generating an optimized model configuration based on the plurality of selected candidate solutions.

13. The system of claim 12, wherein each of the plurality of pools is associated with a distinct algorithm and configured to operate within a distinct search space.

14. The system of claim 12, wherein each of the plurality of pools is associated with a distinct set of compilation settings.

15. The system of claim 12, wherein when the instructions are executed by the processor, the system is caused to perform operation of:
initializing each of the plurality of pools with an identical quantity of candidate solutions.

16. The system of claim 12, wherein when the instructions are executed by the processor, the system is caused to perform operations of:
sampling a specific tuning algorithm based on a sampling probability that is proportional to a number of candidate solutions included in each of the plurality of pools;
generating offspring candidate solutions by performing the sampled specific tuning algorithm within its corresponding pool;
collecting the candidate solutions and the offspring candidate solutions across all of the plurality of pools; and
selecting one or more candidate solutions from the collected candidate solutions and the collected offspring candidate solutions based on at least one unified metric.

17. The system of claim 16, wherein when the instructions are executed by the processor, the system is caused to perform operation of:
after selecting the one or more candidate solutions, redistributing the selected candidate solutions back to their respective corresponding pools.

18. The system of claim 17, wherein each of the plurality of pools retains exclusively those selected candidate solutions that originated from the pool after the selected candidate solutions are redistributed to their respective corresponding pools.

19. The system of claim 18, wherein when the instructions are executed by the processor, the system is caused to perform operations of:
calculating a sampling probability with respect to each pool as a ratio of a number of selected candidate solutions retained in the pool to a total number of selected candidate solutions retained in all of the plurality of pools; and
sampling the specific tuning algorithm based on calculated sampling probabilities.

20. The system of claim 19, wherein when the instructions are executed by the processor, the system is caused to perform operation of:
sampling the specific tuning algorithm corresponding to a pool having a highest sampling probability.

21. The system of claim 16, when the instructions are executed by the processor, the system is caused to perform operation of:
in response to determining that a number of the selected candidate solutions reaches a predetermined threshold, generating the optimized model configuration based on the selected candidate solutions.

22. The system of claim 12, wherein the optimized model configuration is associated with at least one of configuration of layer fusion regarding a deep learning model and configuration of tensor tiling regarding the deep learning model.

23. A non-transitory computer-readable storage medium storing instructions that, when executed by a processor, cause the processor to perform operations of:
initializing a plurality of pools, each including a plurality of candidate solutions;
concurrently performing a plurality of tuning algorithms respectively within the plurality of pools during a single tuning run, thereby obtaining a plurality of selected candidate solutions; and
generating an optimized model configuration based on the plurality of selected candidate solutions.
